(19) United States
(12) Patent Application Publication
(10) Pub. No.: US 2024/0354393 A1
(43) Pub. Date: Oct. 24, 2024

(54) SYSTEM AND METHOD OF GENERATING AUTHENTICATION ASSET USING RADIO FREQUENCY IDENTIFICATION AND EVENT DATA

(71) Applicant: Genuine Inc., San Ramon, CA (US)

(72) Inventor: Chris Savarese, Danville, CA (US)

(21) Appl. No.: 18/634,791

(22) Filed: Apr. 12, 2024

Related U.S. Application Data
(60) Provisional application No. 63/460,565, filed on Apr. 19, 2023.
(60) Provisional application No. 63/598,494, filed on Nov. 13, 2023.
(60) Provisional application No. 63/625,131, filed on Jan. 25, 2024.

(51) Int. Cl. G06F 21/44; G06K 7/10

(52) U.S. Cl. CPC G06F 21/44; G06K 7/10366

(57) ABSTRACT

A radio frequency identification (RFID) authentication system and method includes a RFID reader to capture RFID data associated with a tag on an object at an event. The system includes one or more processors configured to associate the RFID data with one or more of time data or location data representing the event. The one or more processors generate an authentication asset including the RFID data and the one or more of time data or location data. Other embodiments are described and claimed.

This application claims the benefit of U.S. Provisional Application No. 63/460,565, titled “SYSTEM AND METHOD OF AUTHENTICATING PHYSICAL COLLECTIBLES” and filed on Apr. 19, 2023, U.S. Provisional Application No. 63/598,494, titled “RADIO FREQUENCY IDENTIFICATION AUTHENTICATION SYSTEM HAVING VIDEO CAPTURE CAPABILITY” and filed on Nov. 13, 2023, and U.S. Provisional Application No. 63/625,131, titled “RADIO FREQUENCY IDENTIFICATION AUTHENTICATION SYSTEM HAVING VIDEO CAPTURE CAPABILITY” and filed on Jan. 25, 2024, the entire disclosures of which are incorporated herein by reference.

### BACKGROUND

### Field

The present disclosure relates to systems used to authenticate items. More specifically, the present disclosure relates to a radio frequency identification (RFID) authentication system useful for authenticating items, such as physical items used at events.

### Background Information

Fraud is a significant problem in the world of physical collectibles. The industry relies on unsophisticated solutions—including paper certificates of authenticity, database structures that provide inaccurate authenticity information, holograms stickers that can be forged, and the imperfect and unreliable practice of “photo matching.” For example, in sports, Major League Baseball (MLB) is viewed as a gold standard in authentication. The MLB program is decades old, labor-intensive, and often provides inaccurate information (e.g., the MLB database lacks the sophistication necessary to inform a consumer if they are in possession of an authentic collectible or one that has been forged).

### SUMMARY

Existing methods of authenticating physical collectibles used at events, such as sporting events, typically do not allow for real-time association of the physical collectible with event-based data. Such association can provide enhanced authentication and can increase the value of the collectible. The development of such authentication techniques may require radio frequency identification (RFID) authentication systems that can capture video and/or interrogate an event zone, e.g., a playing field, to capture RFID data.

A RFID authentication system is provided. The RFID authentication system can have video capability. In an embodiment, the RFID authentication system includes a mobile RFID reader (for example, a RFID reader having a handle) coupled to a camera. In other embodiments, the RFID authentication system can include one or more fixed RFID readers strategically located at event venues, which may be coupled to a camera or cameras. Such systems are configured to record and display event video, event data, event RFID data, event items, and event participants. The event video can capture and display event video, event data, event RFID data, event items, and event participants simultaneously.

The event video capturing and displaying event data, event RFID data, event items, and event participants simultaneously can be referred to as an “authentication asset” or a “video asset” or an “image asset.” An authentication asset, or image or video asset, can include one or more images of an event. The authentication asset can be stored in a database and can serve as proof that event items were used during certain events, e.g., by certain event participants. In an embodiment, it may be desired to isolate the event video and the event RFID data to focus on individual event items. Due to the nature of RFID technology, isolating individual event items and individual RFID data with event video requires a means of filtering such information. In an embodiment, associating filtered event RFID data with certain event items is contemplated. Such associating of filtered event RFID data with certain event items may be accomplished by incorporating technologies such as machine learning, artificial intelligence (AI), and camera vision.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The present invention is illustrated by way of example and not limitation in the figures of the accompanying drawings in which like references indicate similar elements.

FIG. 1 is a pictorial view of a radio frequency identification (RFID) authentication system, in accordance with an embodiment.

FIG. 2 is a pictorial view of a RFID reader and a reference device of a RFID authentication system, in accordance with an embodiment.

FIG. 3 is a flowchart of a method of generating an authentication asset, in accordance with an embodiment.

FIG. 4 is a pictorial view of a graphical user interface generated by a RFID authentication system to associate an object with an event or a tag, in accordance with an embodiment.

FIG. 5 is a pictorial view of a RFID authentication system operating at a music event, in accordance with an embodiment.

FIG. 6 is a pictorial view of a RFID authentication system having a mobile RFID reader operating at a sporting event, in accordance with an embodiment.

FIG. 7 is a pictorial view of a RFID authentication system having a fixed RFID reader operating at a sporting event, in accordance with an embodiment.

FIG. 8 is a pictorial view of a RFID authentication system having a fixed RFID reader operating at a sporting event, in accordance with an embodiment.

FIG. 9 is a pictorial view of an authentication asset including RFID data, time data, and location data superimposed over one or more images of an event, in accordance with an embodiment.

FIG. 10 is a pictorial view of an authentication asset including filtered RFID data, time data, and location data superimposed over one or more images of an event, in accordance with an embodiment.

FIG. 11 is a pictorial view of an authentication asset including filtered RFID data, time data, and location data superimposed over one or more images of an event, in accordance with an embodiment.

FIG. 12 is a pictorial view of an authentication asset including filtered RFID data, time data, and location data superimposed over one or more images of an event, in accordance with an embodiment.

FIG. 13 is a pictorial view of an authentication asset including filtered RFID data, time data, and location data superimposed over one or more images of an event, in accordance with an embodiment.

FIGS. 14A-14C are pictorial views of digital content of an authentication asset generated for an object, in accordance with an embodiment.

FIG. 15 is a pictorial view of a webpage accessible through digital content of an authentication asset generated for an object, in accordance with an embodiment.

FIG. 16 is a block diagram of an example computing device that may perform one or more of the operations described herein, in accordance with some embodiments.

### DETAILED DESCRIPTION

Various embodiments and aspects will be described with reference to details set below, and the accompanying drawings will illustrate the embodiments. The following description and drawings are illustrative and are not to be construed as limiting the invention. Numerous specific details are described to provide a thorough understanding of various embodiments. However, in certain instances, well-known or conventional details are not described in order to not unnecessarily obscure the present invention in detail.

For clarity, the following terms shall have the following definitions for purposes of describing the provided invention:
Event video. Video that can include video recordings of an event.
Event data. Data that can be data related to an event, such as the date, time, and location of the event, and other metadata that can be associated with the event. Event data may be generated by and/or collected from a location-aware device or a location-confirmed device.
Event RFID data. RFID data than can include unique codes that can be read from RFID tags affixed to physical items used during events.
Event items. Items that can include RFID-tagged physical items used during events.
Event participants. Participants that can be performing in or featured in events.
Location-Aware Device. A device, e.g., a radio frequency identification (RFID) reader, a reference device, a mobile phone, or a camera, having one or more sensors to detect a spatial position, such as a geographic location, of the device. The location-aware device can capture event information, including the spatial position, event time, etc., and generate event data.
Location-Confirmed Device. A device, e.g., a radio frequency identification (RFID) reader, a reference device, a mobile phone, or a camera, having a predetermined spatial position, e.g., geographic location. The device can be placed at, fixed to, or assigned a predetermined location, such as at home plate in a baseball stadium. The location-confirmed device can capture event information, including event time, etc., and generate event data.
   In one embodiment of the present invention, event data and event RFID data can be visually coupled to the event video (e.g., superimposed over) and/or embedded in the event video.

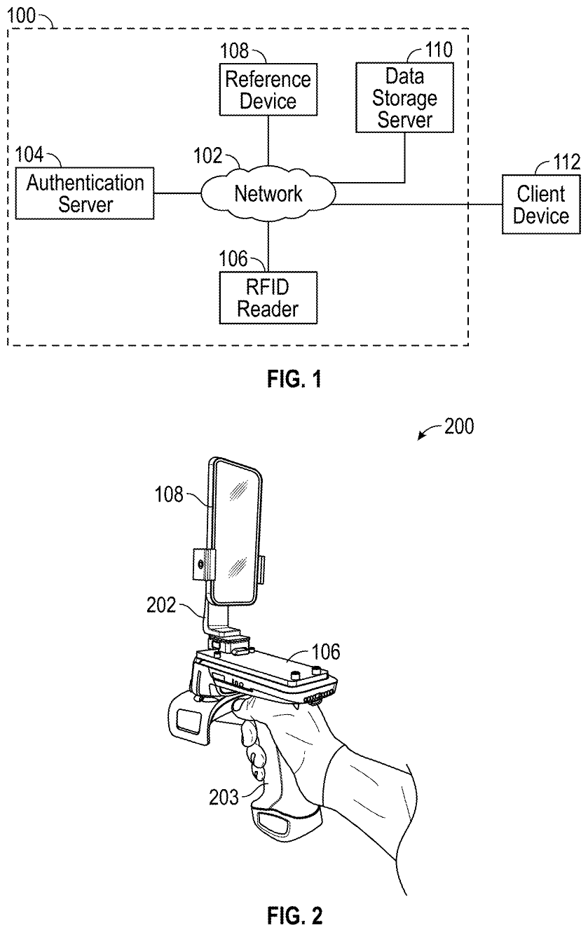

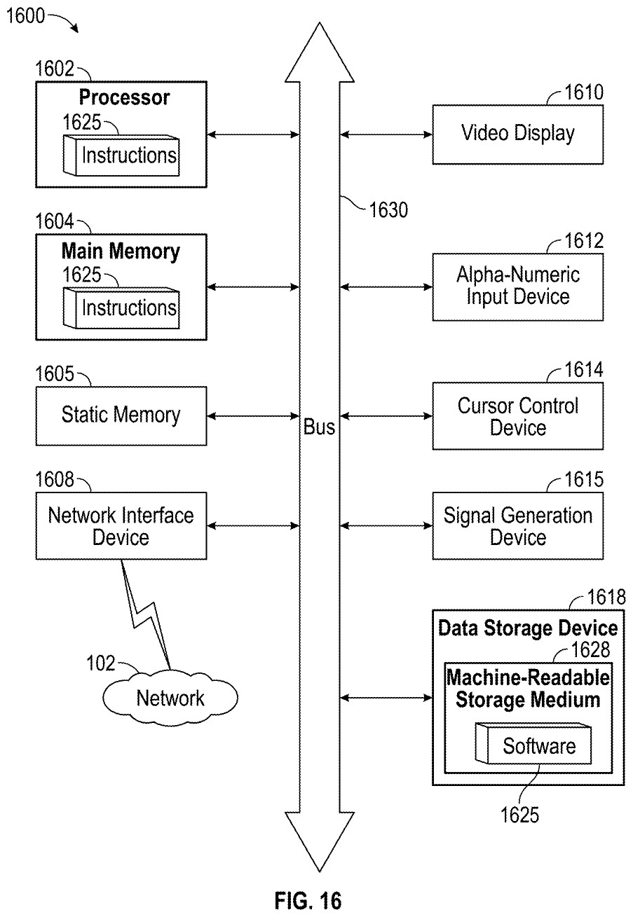

Referring to FIG. 1, a pictorial view of a radio frequency identification (RFID) authentication system is shown in accordance with an embodiment. A RFID authentication system 100 can include several components in communication with each other through a network 102. More particularly, each of the components can be a computing system or a computing device (FIG. 16) capable of communicating data to other components in the system. For example, an authentication server 104 can receive RFID data captured by a RFID reader 106, as described below. The RFID data can be associated with a tag on an object at an event. Similarly, a reference device 108 can communicate event-based data, such as time data or location data representing the event, to the authentication server 104. The authentication server 104 can receive such data and generate an authentication asset that provides proof that the object was present and/or used at the event. Accordingly, the authentication asset can be transmitted to and stored on a data storage server 110 for future access and proof. For example, a client device 112, e.g., a computer of a system user, may access the authentication asset stored on the data storage server 110 through the network 102 to provide proof of authenticity of the object, which the consumer may have purchased as memorabilia of the event.

Referring to FIG. 2, a pictorial view of a RFID reader and a reference device of a RFID authentication system is shown in accordance with an embodiment. The RFID authentication system 100 can include a RFID scanning system 200 having the RFID reader 106. In an embodiment, the RFID scanning system 200 includes a device mount 202 connected to the RFID reader 106. The device mount 202 can attach to, e.g., grip, the reference device 108 to physically connect the reference device 108 to the RFID reader 106.

The RFID reader 106 can include a handle 203, a housing, and RFID scanning circuitry contained by the housing. The handle 203 can be grasped by a user. The handle 203 can protrude from the housing such that the user can hold the grip to control an orientation of the housing. RFID scanning circuitry, e.g., an antenna, can be stored in the housing. The RFID reader 106 can be a scanner of any of several RFID reader types, including a passive reader or an active reader. For example, the RFID reader 106 can be an active RFID reader having the antenna operating in the UHF band to provide long-range reading capability, e.g., in a range of up to about 300 feet.

The device mount 202 can hold a camera or a camera lens. In an embodiment, the device mount 202 includes a housing containing the camera. More particularly, the RFID scanning system 200 may have an integral camera (or reference device 108). Alternatively, the device mount 202 may include a structure, such as a gripper, that an external reference device 108, optionally having a camera, may be loaded into. For example, the reference device 108 can include a mobile device, such as a mobile phone, which can be mounted on the device mount 202.

The camera mounted on or integrated within the device mount 202 can be used to capture one or more images, e.g., video, of an event. For example, the captured video may be of a player on a sports field wearing a jersey having a RFID tag. The RFID reader 106 or the reference device 108 mounted on the device mount 202 can include one or more of processors or sensors to generate real-time data associated with the event. For example, the RFID reader 106 or the reference device 108 associated with the RFID reader 106 can include one or more processors or sensors to generate location data (e.g., a GPS sensor), time data (e.g., a clock), or other event-based data that can be associated with the RFID data captured from the tag and/or jersey. Accordingly, it will be appreciated that the reference device 108 and/or the RFID reader 106 may be location-aware or location-confirmed devices (and thus, capable of generating location data) and may also be time-aware devices (capable of generating time data). The reference device 108 and the RFID reader 106 may be integrally housed, physically coupled, or proximately placed to allow location data generated by either device to be associated with and/or referenced against time data generated by either device.

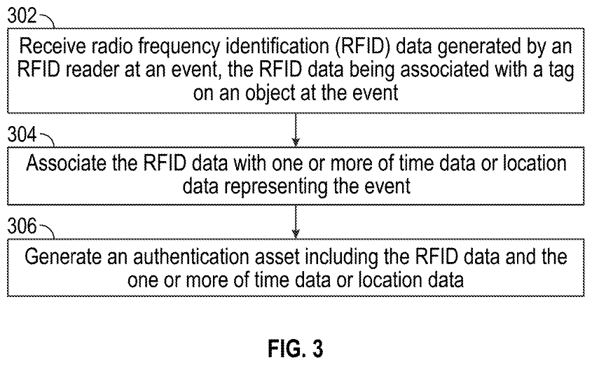

Referring to FIG. 3, a flowchart of a method of generating an authentication asset is shown in accordance with an embodiment. By way of summary, and as described below, data generated by the RFID reader 106 at an event can be associated with event data representing the event. The event data can include video captured by the camera, or other event-based data, such as date, time, location, etc., of the event. The associated data, e.g., the RFID data and one or more of the time data or the location data, can be used to generate an authentication asset used to prove that an object was used at the event. For example, the associated data can be superimposed on and/or associated as metadata with frames of the captured video. Operations 302-306 of the method are referred to in the following description.

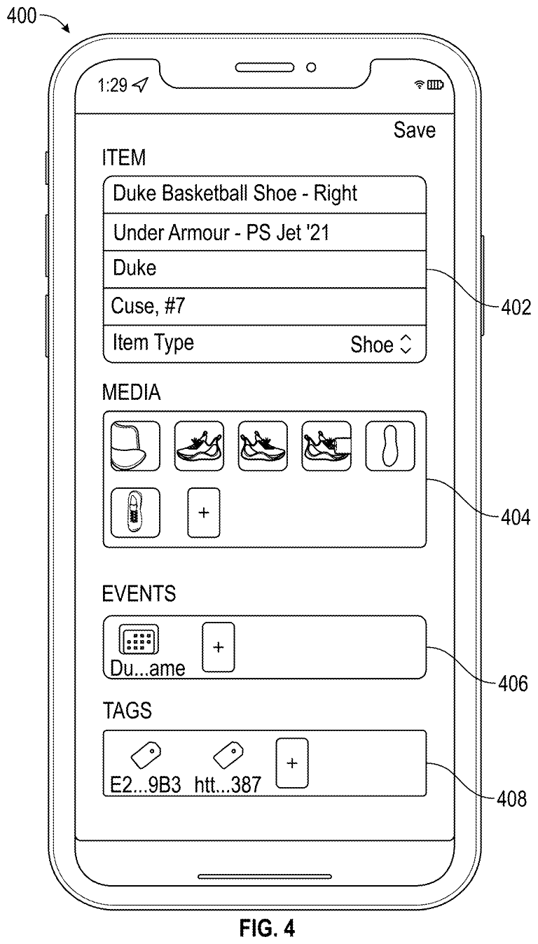

Referring to FIG. 4, a pictorial view of a graphical user interface generated by a RFID authentication system 100 to associate an object with an event or a tag is shown in accordance with an embodiment. The graphical user interface 400 may be generated by a computing system running application software. For example, the client device 112 may run the application software to present the graphical user interface 400 to a user. The user can interact with graphical user interface 400 to input item data 402 associated with an item, e.g., an object. By way of example, the item can be a basketball shoe, and the item data 402 may represent the shoe. As shown, the item data 402 can include data representing the object and/or a participant in an event that uses the object. For example, the basketball shoe can be a right foot shoe, used by a participant named Duke having a jersey #7 on a team named the “Cuse.”

The graphical user interface 400 can allow the user to input media data 404 associated with the object. For example, one or more photos of the object can be stored via the graphical user interface 400 at the authentication server 104. The photos may be transmitted from the client device 112, on which the graphical user interface 400 is presented, to the authentication server 104. An example of photos representing the object can include images, e.g., front, side, top, bottom, or rear images of the object. Such external images can be used to identify unique features apparent in the object, such as a scuff on a heel of the shoe.

The graphical user interface 400 can allow the user to input event data 406 associated with the object. For example, the event data 406 can include a calendar entry for a game in which the item will or has been used by the participant. The event can be a basketball game at which the participant, Duke, wore the shoe, for example. The event data 406, e.g., the calendar entry, can include time data or location data associated with the event. More particularly, the event data 406 can include a timeframe during which the game will be or was played, or a location where the game will be or was played.

In an embodiment, the user can input tag data 408. The tag data 408 may, for example, include a unique identification code associated with a tag on the object. The tag may, for example, be embedded in the object. Accordingly, the tag is associated with the object, and by extension, the object is associated with the unique identification code of the tag. Accordingly, when the tag is interrogated, e.g., by a RFID reader 106, the reader is by extension interrogating the object.

Data associated with the object, which can be input by a user of the client device 112, can be stored at the authentication server 104 for future reference. For example, the item data 402, media data 404, event data 406, or tag data 408, can be input and stored prior to the object being used at an event. As described below, when the object is used at the event, and the tag associated with the object is interrogated, data received from the tag can be referenced or matched against the previously input data to authenticate the use of the item at the event.

The data associated with the object may be referred to as associated content. The software application, e.g., an event application, is used by the user to list items and their associated events and tags. The software application can also associate the items with participants. Separately, the tag, whose identification code is associated with the item, can be physically affixed to the item. Accordingly, when the RFID reader 106 detects the tag, the unique identification codes can be captured and/or displayed in real time.

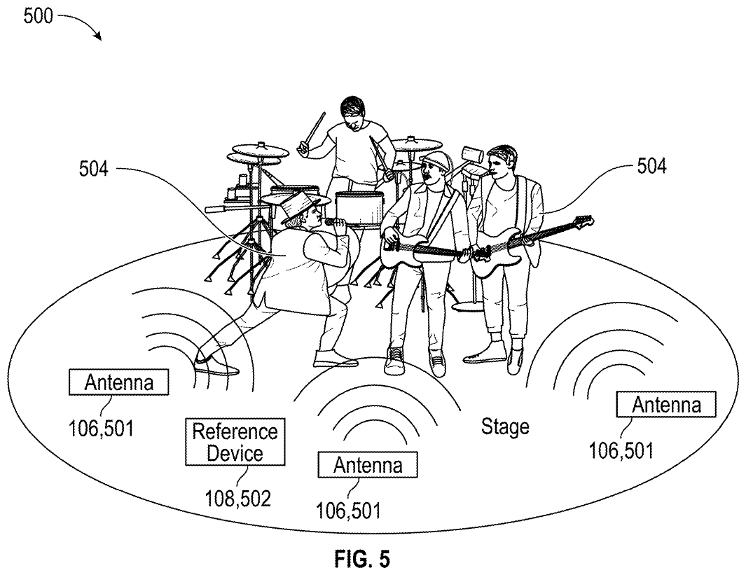

Referring to FIG. 5, a pictorial view of a RFID authentication system operating at a music event is shown in accordance with an embodiment. The RFID authentication system 100 can include one or more RFID readers 106 at an event venue. For example, a RFID reader 106 can be fixed RFID reader antenna at an event venue. The RFID reader 106 may be used, as described below, to capture RFID data associated with a tag on an object at an event being performed at the event venue.

The RFID authentication system 100 includes one or more location-aware or location-confirmed devices. For example, the location-aware or location-confirmed devices of the RFID authentication system 100 can include one or more RFID reader 106 antennas and one or more reference devices 108, e.g., a mobile device having a camera 502. The RFID reader(s) 106 and reference device(s) can capture event information. For example, a reference device 108 having a camera 502 can capture one or more images of a band (event participants 504) performing at a concert (event). The image(s) can include items used by the event participants 504 during the event, e.g., a microphone, guitars, drumsticks, a top hat, etc. The RFID reader 106, like the reference device 108, can capture event information related to the event participants 504 or items used by the event participants 504. For example, the items may be tagged by corresponding RFID tags, and the RFID reader 106 can interrogate the RFID tags to obtain information about the items, such as unique item codes associated with the items.

The location-aware or location-confirmed devices can be located around at the event venue 500 (e.g., concert stage) and configured to detect and/or interrogate all event items and event participants 504 on the concert stage. In the case of a location-aware device, the device may move about the venue, and the device can detect the location of the device during such movement. In the case of a location-confirmed device, the device may, in addition to or instead of having a position sensor, be assigned a location at the venue. For example, a user may manually assign spatial or geographic coordinates to the location-confirmed device using a system interface. Various manners of assigning the location of the location-confirmed device are contemplated. By way of example, the user may stand beside the location-confirmed device with a location-aware device, such as a mobile phone. The mobile phone can have a software application running to allow the user to log the spatial position of mobile phone as the predetermined location of the location-confirmed device. The location-confirmed device may then remain fixed at the spatial position or moved elsewhere. Event-based data generated by the location-confirmed device may, however, be associated with the predetermined location regardless of whether the location-confirmed device remains in place.

A spatial position of the location-aware devices can be sensed during the event. For example, the RFID reader 106 and/or reference device 108 (e.g., having camera 502) can include receivers and/or antennas that function within a positioning system, e.g., a global positioning system (GPS), to generate data corresponding to a geographic location of the devices. More particularly, in an embodiment, the RFID reader 106 and/or reference device 108 include a GPS sensor to detect positioning signals and one or more processors of the RFID authentication system 100 determined, based on the positioning signals, the geographic location of the location-aware device. It will be appreciated that the location can be one type of event data that may be captured and associated with images of the event. In the case of location-confirmed devices, the location can be predetermined and can be output as event data along with other event data captured by the location-confirmed device. For example, as described below, the location may be described in metadata that is superimposed, along with date, time, RFID tag codes of an item, etc., on an image of the event and/or item.

In an embodiment, a means of sensing when RF-enabled event equipment (e.g., wireless microphones and/or musical instruments) is not in use is contemplated. To avoid potential RF interference between RF-enabled event equipment and the RFID authentication system 100 described herein, the RFID authentication system 100 is configured to identify when the event equipment is transmitting RF signals, e.g., wireless signals of audio equipment, so the RFID authentication system 100 can operate when the event equipment is not, thereby not creating RF interference. RF transceivers configured to receive and “learn” transmission frequencies of the event equipment can communicate with the RFID authentication system 100, identifying appropriate times for the RFID authentication system 100 to transmit and receive signals. Accordingly, the method can include determining whether event equipment at the event is transmitting RF signals, and capturing RFID data in response to determining that the event equipment is not transmitting RF signals.

Given the concepts described above, it will be appreciated that, at operation 302, RFID data generated by the RFID reader 106 can be received, e.g., by the authentication server 104. The RFID reader 106 can interrogate the tags at the event to generate RFID data. The generated RFID data can, for example, include the RFID tag codes. The RFID data can be associated with the tag on the object, e.g., a guitar, at the event. The generated data can be transmitted to the authentication server 104.

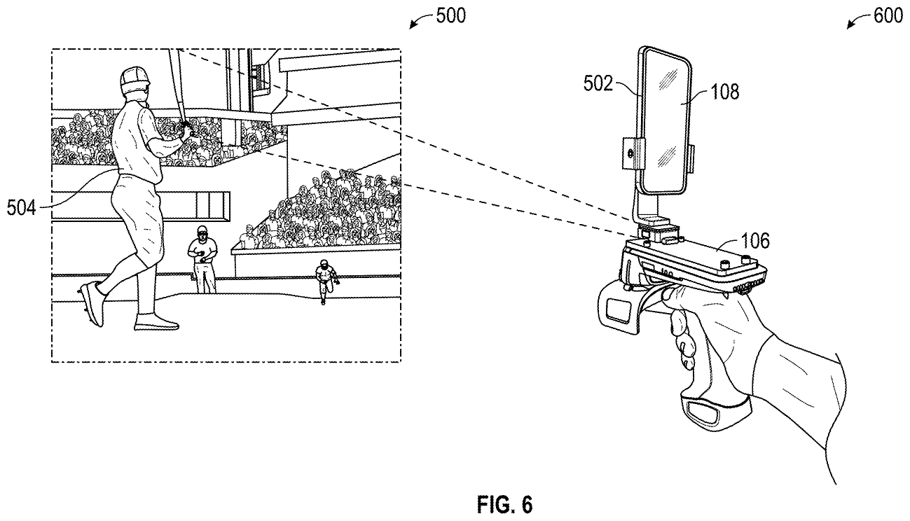

Referring to FIG. 6, a pictorial view of a RFID authentication system having a mobile RFID reader operating at a sporting event is shown in accordance with an embodiment. A mobile RFID system 600 can include a coupled reference device 108 having camera 502. The system may be used to authenticate event items at the example event.

The mobile RFID system 600 can be used to authenticate items at an event being performed at the event venue 500, such as a Major League Baseball game. In this example, a human resource can operate the mobile RFID system 600 at strategic locations during the event. One example of a strategic location is the area between the batter's on-deck circle and home plate, as shown. In this location, event participants 504 with RFID-tagged event items such as a jersey, bat, helmet/hat, gloves, cleats, etc. can be captured reliably as nearly all participants 504 in a baseball game (with exception of pitchers in some cases) will pass through this location prior to batting.

As described above, the RFID reader 106 can interrogate the tag to determine the unique tagged code associated with the object, e.g., a bat. In an embodiment, the camera 502 is a component of a mobile device 108. The mobile device may, for example, be a mobile phone. The mobile phone can be physically attached to the RFID reader 106. The physical coupling of the RFID reader 106 to the camera 502 can ensure that codes read by the RFID reader 106 are associated in time and space with the images captured by the camera 502. For example, when the tag is interrogated at a time by the RFID reader 106 and an image of the object having the tag is captured by the camera 502, then it can be determined that the object was at the event being imaged. The time of interrogation or image capture can be tracked using a real-time clock of the RFID reader 106, the camera 502, or another device that generates time data to authenticate the presence of the object at the event where the image was captured.

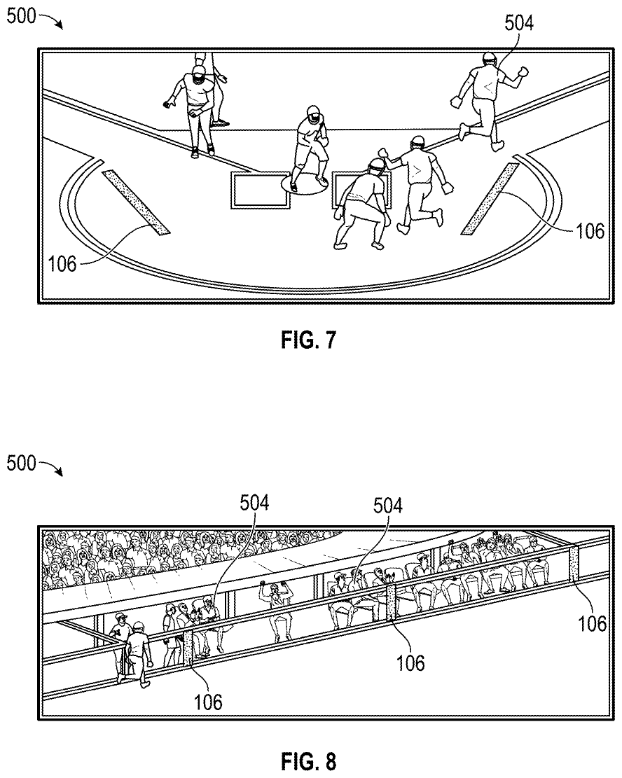

Referring to FIG. 7, a pictorial view of a RFID authentication system having a fixed RFID reader operating at a sporting event is shown in accordance with an embodiment. Fixed RFID readers/antennas 106 can be strategically located at an example event to interrogate event items in a certain event area (e.g., the home plate area at a baseball game or a pitcher's mound area at the baseball game (not shown)).

The strategic location at an event with fixed RFID reader 106 antennas located to automatically capture event RFID data from tagged event items. The strategic location can be a location passed by the object during the event. More particularly, the RFID reader 106 can be fixed to the venue at the location passed by the object during the event. The example strategic location is the area surrounding home plate at a Major League Baseball game. In an embodiment, RFID reader 106 antennas can be located such that event participants 504 pass over the RFID antennas each time they approach home plate. The RFID readers 106 antennas can be installed in various ways. For example, depending on the RF performance, antennas can be buried a few inches below the surface of the home plate dirt area. Alternatively, the antennas can be installed at surface level, adjacent to the grass areas surrounding home plate, and the antennas can be built into apparatuses that include artificial turf (such that the antenna apparatuses blend in visually with the surrounding). There are various potential configurations for strategically placed fixed RFID antennas around the home plate area. For example, home plate itself can be configured with an integrated antenna, as can various other locations surrounding home plate. In some embodiments, mobile RFID readers 106 and/or antennas can be strategically positioned equipment. For example, a RFID antenna can be positioned inside the home plate umpire's equipment (e.g., such as the umpire's chest protector) or the catcher's equipment. One potential advantage of using fixed RFID readers/antennas (vs. mobile) is the fixed RFID systems have different transmission restrictions (e.g., legal restrictions governed by the FCC in the USA for example) and may be able to interrogate a larger area, capturing more tagged event items in a certain area than mobile RFID systems 600. In certain embodiments, the RFID readers 106 can be located at a distance away from the RFID antennas. If the distance between the RFID reader 106 and RFID reader 106 antennas is significant (for example, 20 feet or more) highly insulated RF cables can be used to minimize RF loss and maximize performance.

Referring to FIG. 8, a pictorial view of a RFID authentication system having a fixed RFID operating at a sporting event is shown in accordance with an embodiment. Fixed RFID readers/antennas can be strategically located at an example event to interrogate event items in a certain event area (e.g., the dugout area at a baseball game).

The strategic location at an event with fixed RFID reader 501 antennas is located to automatically capture event RFID data from tagged event items. The example strategic location is the dugout area at a Major League Baseball game. In an embodiment, RFID reader 106 antennas can be located such that event participants 504 pass by the readers/antennas on their way into and out of the dugout. This configuration can include readers and/or antennas that are padded for protection from event objects (e.g., baseballs) and event participants 504 (e.g., baseball players). The configuration shown in FIG. 8 could be helpful in capturing event participant items that they do not wear or use while batting. If the event venue 500 includes a RFID reader/antenna configuration at home plate, for example, that configuration can capture all event items an event participant 504 is wearing or using while batting. An example of an item not used while batting is a fielder's glove. The reader/antenna configurations would help capture event participants' fielding gloves (and any other equipment not worn at home plate) as participants enter and exit the dugout on their way to and from the baseball diamond. A baseball cap is another example of an item a participant 504 might not wear at home plate, as most baseball players do not wear their cap under their batting helmet.

In an embodiment, the strategic location at an event with a fixed RFID reader 501 antenna located to automatically capture event RFID data from tagged event items can be a pitcher's mound area at a Major League Baseball game (not shown). In an embodiment, a RFID reader 106 antenna can be located behind the pitcher's rubber, also known as the pitching plate, such that the antenna can capture tagged event items including such as tagged baseballs and pitcher items (including cleats, jerseys, fielder's glove, hat, etc.). This configuration can include a reader antenna that is either slightly below the surface of the pitcher's mound dirt or at surface level, on the back of the mound. In baseball, the pitcher does not always hit or come near the home plate area, so such configuration could be helpful in capturing pitcher-related event items. Further, if a RFID reader/antenna configuration at home plate was not able to capture tagged RFID baseballs, the configuration on the pitching mound should be able to reliably capture the baseball prior to every pitch. In an embodiment, the RFID reader 106 antenna could be embedded within the pitcher's rubber/plate.

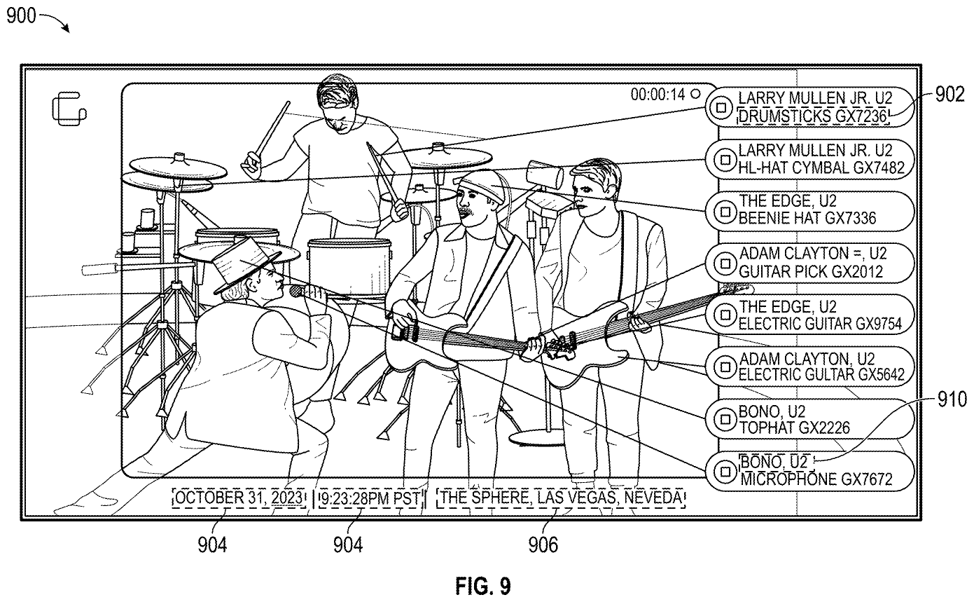

Referring to FIG. 9, a pictorial view of an authentication asset including RFID data, time data, and location data superimposed over one or more images of an event is shown in accordance with an embodiment. As described above, at operation 302, the RFID data associated with the tag can be received. The RFID data can be generated by the RFID reader 106. At operation 304, the RFID data 902 is associated with one or more of time data 904 or location data 906 representing the event. As described above, the components of the RFID authentication system 100, e.g., the RFID reader 106, the reference device 108, etc. can be location-aware, location-confirmed, and/or time-aware. The components may therefore generate time data 904 and location data 906. More particularly, the time data 904 or location data 906 may be captured by a component of the RFID authentication system 100. For example, the reference device 108, which may be physically coupled to the RFID reader 106, can generate date, time, or location data at the event. The time data 904 can be a timestamp. The location data 906 can be a GPS location. The time data 904 or the location data 906 represents the event because the data describes characteristics of the event. More particularly, the event occurred at the time described by the time data 904, and at the location described by the location data 906. The reference data generated by the reference device 108 can be transmitted to the authentication server 104. In an embodiment, the authentication server 104 received the RFID data 902 and the event-based data and associates the data in combined data of the authentication asset 900.

At operation 306, and authentication asset 900 is generated. The authentication asset 900 may be generated, for example, by the authentication server 104. The authentication asset 900 can include a digital asset containing one or more of an image, a video, time data 904, or location data 906. Furthermore, in an embodiment, the authentication asset 900 includes RFID data 902. More particularly, the authentication asset 900 can include the RFID data 902 generated by the RFID reader 106 and one or more of the time data 904 or the location data 906 generated by the reference device 108, the data having been associated with each other. For example, the authentication asset 900 shown in FIG. 9 includes both the time data 904 and the location data 906 associated with the RFID data 902. The tagged drumstick is therefore known (or authenticated) as being present at the indicated time and place of the event.

A RFID authentication system 100 authentication asset 900 captured at an event venue 500 is shown. As described above, location-aware or location-confirmed devices can capture event data, which may be superimposed over images of the event. Event data can include the time data 904 or location data 906 associated with the event date, time, and location. The event data can be superimposed over (and/or embedded in) one or more images of the event, such as a video of the event. More particularly, the method can include capturing one or more images of the object being used at the event, and the authentication asset 900 can include the one or more images. Event RFID data 902, also superimposed over (and/or embedded in) the event video, includes examples of associated event items such as drumsticks, hats, guitars, etc. Each event item has an affixed RFID tag, and each RFID tag includes a unique RFID code (i.e., the event RFID data 902). Each event item's associated unique code (or portion of the unique code) can be displayed in the video, along with the other associated data. Accordingly, a data-rich authentication asset 900 (or image or video asset) can be generated that serves as proof that the event item was used at the event.

Each event item can be associated with event participants 504, such as individual performers. The one or more images captured by the camera 502, e.g., the camera 502 of a mobile device, can include video of the participant 504 using the object at the event. For example, a singer singing into a microphone having a tag that was interrogated by the RFID reader 106 at the event. In an embodiment, the method includes associating the RFID data 902 with participant data 910 representing the participant 504. The RFID data 902 can be the unique tag code captured by the RFID reader 106. The participant data 910 can be participant data 910 input by a user of the system, such as through entry of item data 402 (including participant data 910, e.g., “Duke” in the example of FIG. 4). As shown in FIG. 9, the participant data 910 entered into the graphical user interface 400 could have been the name “Bono” indicating a user of a microphone having the item data 402, including the unique tag code shown. In an embodiment, the authentication server 104 associates the received RFID data 902 with the participant data 910 to display both data.

The associating of tagged event items with event participants 504 can be done “manually” (e.g., by an individual operating the RFID authentication system 100 associating an item with a participant 504 using the RFID authentication system 100 interface/software) prior to the event, or, in an embodiment, machine learning/AI/camera vision technology can be used to automate the association of event items with event participants 504. In the automated embodiment, the RFID system software can “learn” attributes of event participants 504. An operator of the RFID authentication system 100 can, for example, scan an event item (e.g., a tagged microphone with code Gx7672) and associate the item with an event participant 504 that has previously been “learned” by the RFID authentication system's integrated camera 502 vision system (e.g., “Bono”). The system can assign the participant “Bono” as a system item with a participant code (e.g., Gx1234). Note: the participant code is not shown in FIG. 2. During an event, when the system reads RFID code Gx7672 (Bono's microphone), the system is instructed to interrogate for a camera vision match of system item Gx1234 (Bono). Once a camera vision match is identified, the system can associate the event item (Bono's microphone) with the event participate (Bono). This association can be made by associating the data representing “Bono” and “Bono's microphone” in a database and the association can be made visually, by visually connecting Bono with Bono's microphone (for example, a line leading from the text “Bono's microphone” to the participant 504 “Bono”).

Still referring to FIG. 9, the method can include displaying the authentication asset 900, e.g., by a display of one of the client devices networked to the authentication server 104. The authentication asset 900, which is displayed for view by a user, includes the RFID data 902 (e.g., the unique tag code), one or more of the time data 904 or the location data 906 (e.g., both the time data 904 and the location data 906), and the participant data 910 (e.g., a name of the participant 504). The displayed data can be superimposed on the one or more images of the event. Accordingly, the authentication asset 900 can include an image taken at an event and data representing objects and/or participants 504 that are known to be associated with tags interrogated at the event. The authentication asset 900 can therefore be used to authenticate the presence of the object and/or participants 504 at the event, including use of the object by the participant 504 at the event.

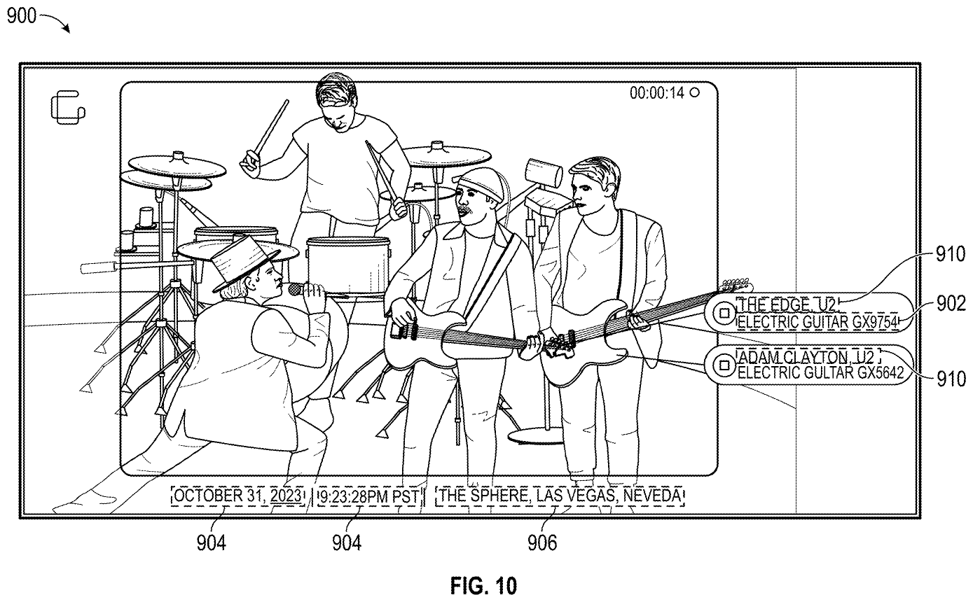

Referring to FIG. 10, a pictorial view of an authentication asset including filtered RFID data, time data, and location data superimposed over one or more images of an event is shown in accordance with an embodiment. In an embodiment, the method includes filtering one or more of the RFID data 902 or the participant data 910 based on one or more of an object parameter or a participant parameter. FIG. 10 illustrates a view of an authentication asset 900 displaying an event with event data and event RFID data 902 superimposed over event video. The event RFID data 902 is filtered to display a user-defined set of event RFID data related to certain event items. For example, displaying event items of a certain type only.

The event data and event RFID data 902 is superimposed over the event video. An object parameter can be input to the system, such as a parameter instructing the system to only display guitars. In response to the input, the one or more processors of the authentication server 104 (or another system component) can generate the authentication asset 900 that includes RFID data 902 which has been filtered to display only items with types defined as “guitars.”

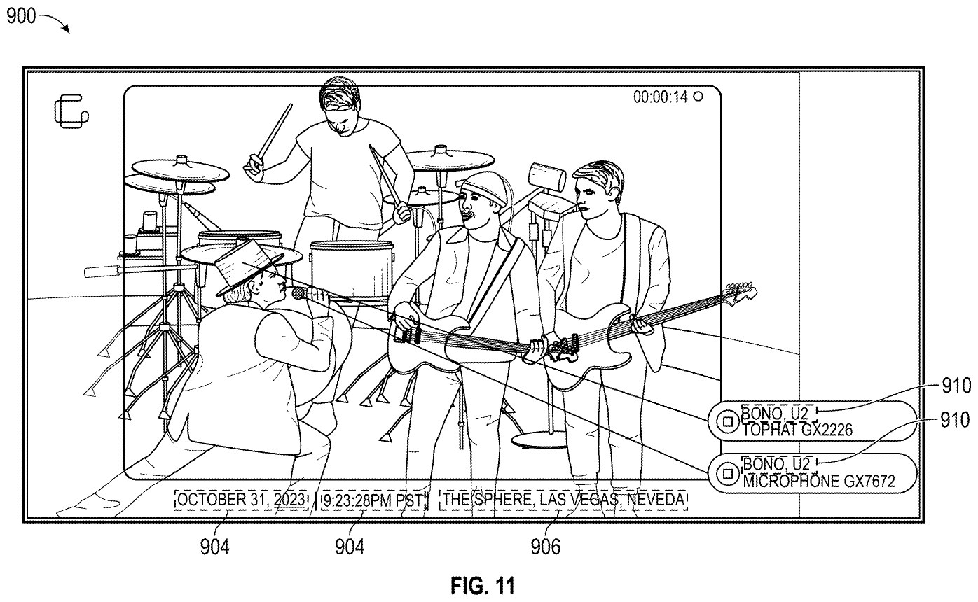

Referring to FIG. 11, a pictorial view of an authentication asset including filtered RFID data, time data, and location data superimposed over one or more images of an event is shown in accordance with an embodiment. FIG. 11 illustrates a view of an authentication asset 900 displaying an event with event data and event RFID data 902 superimposed over event video. A participant parameter can be input to the system, such as a parameter instructing the system to only display objects associated with and/or being used by a participant 504 named “Bono.” In response to the input, the event RFID data 902 is filtered to display a user-defined set of event RFID data 902 related to certain event items. For example, displaying only event items associated with a particular event participant 504 performing at the event. Still referring to FIG. 11, an authentication asset 900 is shown. The event data and event RFID data 902 is superimposed over the event video. The event RFID data 902 has been filtered to display only items associated with event participant 504 “Bono.”

Based on the description above, it will be understood that images captured by the camera 502, RFID data 902 captured by the RFID reader 106, and event data captured by the reference device 108 or the RFID reader 106 can be combined to generate an authentication asset 900 authenticating the presence or use of an item at an event and/or by an event participant 504 at the event. More particularly, the authentication asset 900 can be accessed to verify the authenticity of the tagged items. Referring again to FIG. 9, the authentication asset 900 may be referred to as a first authentication asset 900. The first authentication asset 900 can include a first set of event information captured by the location-aware or location-confirmed devices and associated with the image or video frame. For example, a first set of identified event participants 504, event item, and other overlay image can be present in the first authentication asset. By contrast, FIGS. 10 and 11 include authentication assets 900 that may be referred to as second authentication assets. The second authentication assets can be filtered, as described above, to include a second set of event information, e.g., only event information that meets predetermined criteria, such as event information associated with specific item(s). It will be appreciated that the first authentication asset and the second authentication asset(s) include a same image and, thus, correspond to a same moment in time at the event. The overlay information associated with the different authentication assets 900, however, may differ. Accordingly, the authentication assets 900 may be stored and used for alternative purposes, as described below.

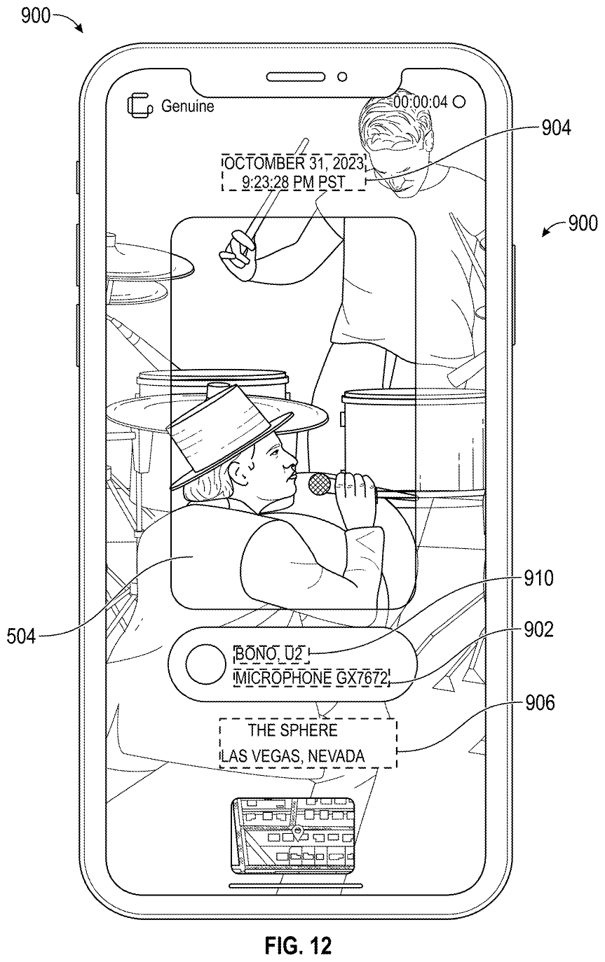

Referring to FIG. 12, a pictorial view of an authentication asset including filtered RFID data, time data, and location data superimposed over one or more images of an event is shown in accordance with an embodiment. More particularly, FIG. 12 illustrates an example of authentication assets 900 filtered to display certain event items with certain event RFID data 902.

Authentication asset 900 displays event participant 504 “Bono” and event item “Bono's microphone.” The authentication asset 900 view is zoomed in to focus on the specified event item and event participant 504. The RFID authentication system 100 can automate the focusing on specific event items and event participants 504 using the camera vision association described above. For example, the system can be instructed to only display event item with event RFID data equal to “Gx7672 (Bono's microphone).” Once the event item with event RFID data Gx7672 is identified, the system can associate the event item with the learned event participant 504. Once the association between the event item and the event participant 504 is made, the system can be instructed to use pre-determined parameters (e.g., the outer-most images of the event participation plus a predetermined border value) to focus on specific items, thereby creating an individualized authentication asset 900. Similarly, upon identifying a learned event participant 504, the system can be programmed to systematically display certain event items associated with the event participant 504 and capture individualized authentication assets 900 for each event item associated with the event participant 504. For example, the system can identify Bono, then display the event RFID data 902 for Bono's hat, focus on Bono, his hat, and the event RFID data 902 for his hat, and create an authentication asset 900 for Bono's hat. Then the system can move on to another item associated with Bono (e.g., Bono's microphone) and repeat the process above. This process can be repeated until individualized authentication assets 900 for each event item associated with Bono have been captured.

It will be appreciated that authentication asset 900 is a filtered authentication asset, which is based on the first authentication asset. More particularly, the authentication asset 900 having overlay information, such as item codes, for all items used at the event can be edited and filtered to generate the authentication asset 900 having overlay information for one item (the microphone used by Bono). The authentication asset 900 may be a presentation-grade version of the authentication asset 900, which can be stored on blockchain, as described below. The authentication asset 900 can provide proof that the item was used at the event. In an embodiment, the authentication asset 900 may also be stored, e.g., on blockchain, for access, to confirm authenticity of the authentication asset 900 and/or item. For example, the authentication asset 900 showing several item tag codes can be stored on blockchain, and may be accessed by a user to compare against the authentication asset 900. Comparison of the authentication assets 900, including information captured and associated with both authentication assets 900, can verify the authenticity of the item as being used at the event.

The authentication assets 900 described herein can be based on, or generated from, raw data collected or generated by one or more location-aware or location-confirmed devices. A location-aware or location-confirmed RFID reader 106 can scan several RFID codes from event items recorded during an event. By way of example, a RFID reader 106 can scan tens or hundreds of event items during a few seconds at the event. The scanned codes can be stored as event data, and may be termed raw data. The raw data may include an unfiltered listing of data, e.g., RFID codes of items, a time that the items were scanned, and locations of the items, captured during the few seconds.

Presentation of an icon for each of the raw data items may be unwieldly. More particularly, it may be distracting to present overlay information for all of the tens or hundreds of scanned items on an authentication asset 900. Accordingly, the raw data can be filtered to generate authentication asset(s) that provide relevant information to a user for item(s) of interest, such as shown in authentication assets 900, above. The authentication asset 900 including filtered data can provide a clean video asset to be stored online, on chain. Filtering can be performed in real-time, e.g., within software application running on the mobile device that is capturing video of the event.

Despite not being displayed, the raw data may nonetheless be stored for future access. For example, the listing of item information may be stored on blockchain for future access and reference. The stored raw data may be used for authentication purposes. In an embodiment, the RFID authentication system 100 can receive stored raw data, receive an input of a unique code for an item that is allegedly an event item, and determine, based on the raw data, that the item is the event item. More particularly, the system can access the raw reader data, which includes time, location, RFID codes, etc., to match the data against input data, such as a unique code of an item possessed by an individual. The system can perform a comparison to authenticate the item as a genuine event item.

The stored raw data may also be used to generate an authentication asset 900. The stored raw data generated by location-aware or location-confirmed devices at an event may be matched against or associated with video footage taken at a known time, location, or direction at an event. For example, a location-confirmed device at a home plate may scan a unique code associated with a bat when a batter carries the bat into a batter's box at the home plate. The scan can occur at a moment in time, and the event data generated by the location-confirmed device can include the location of the home plate, the moment in time, and the unique code. Video footage may be captured along with metadata, such as a timestamp, a location of a camera 502, and a direction of the camera 502. The camera metadata can be used to confirm that, based on the camera location and direction, the video footage is taken of the home plate at the time the scan was performed. Accordingly, the video footage may be matched to the raw data and used to produce an authentic authentication asset 900 of the moment, which authenticates the use of the bat at the event, e.g., during a specific at bat.

In the above examples, the authentication asset 900 includes one or more images of the event. There may be occasions in which media rights to film an event have not been obtained by an operator of the RFID authentication system 100. In such case, images or video of the event may not be captured. It is contemplated, however, that the authentication asset 900 may include an image representative of the event. For example, an image displaying a title of the event, e.g., U2 Live @ The Sphere, may be included in the authentication asset 900. The various representative data, e.g., the RFID data 902, the item data 402 associated with the RFID data, the participant data 910, etc., may be superimposed are overlaid on the representative still image.

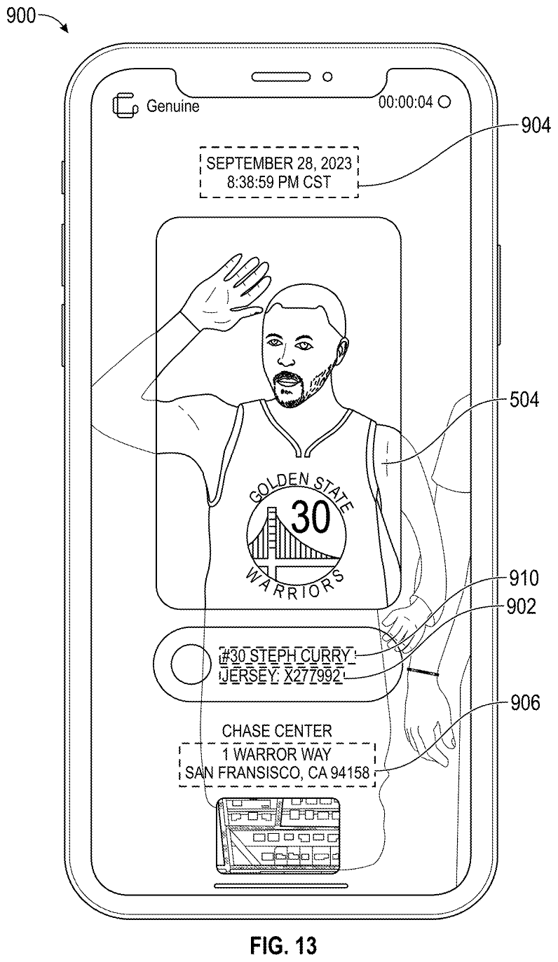

Referring to FIG. 13, a pictorial view of an authentication asset including filtered RFID data, time data, and location data superimposed over one or more images of an event is shown in accordance with an embodiment. Another individualized authentication asset 900 can be an authentication asset 900 showing an example of a sporting event with event participant 504 “Steph Curry” associated with event item “Jersey X277992.” In this example, the system was instructed to display only event RFID data 902 equal to “X277922” and associated with event participant 504 “Steph Curry” (i.e., a code representing “Steph Curry”). In response, the authentication asset 900 was generated having the associated participant data 910 and item data superimposed on an image of the event in which Steph Curry is playing. Steph Curry's visual attributes may have been learned and stored in the system and matched using camera 502 vision/machine learning. Once matched, the system focuses or “crops” the displayed video to create the individualized authentication asset 900.

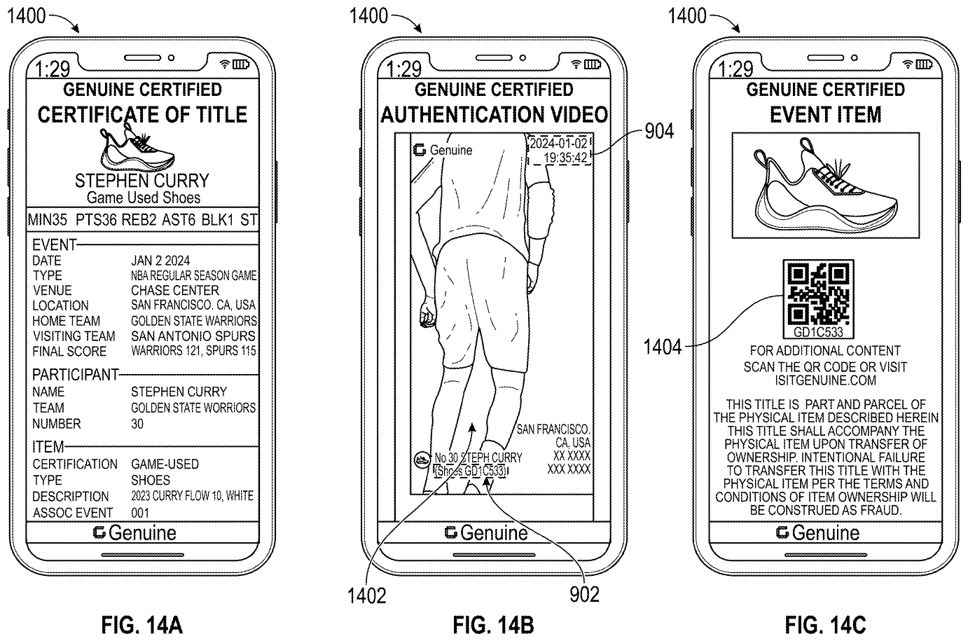

As described below with respect to FIGS. 14A, the authentication asset 900 can be incorporated in a digital object 1400 stored in a database to serve as proof that certain physical items were used during certain events. More particularly, the authentication asset 900 can be a digital title associated with the object. The digital object 1400 may be a non-fungible token (NFT) and may include a “authentication asset 900” as described herein and other information describing the event, the event items, and event data.

The digital object 1400 can serve as proof that certain physical items were used during certain events. In one embodiment, the digital object 1400 is an NFT stored on Blockchain. It is contemplated that the digital object 1400 (e.g., NFT) may include a “authentication asset 900” as described herein and other information describing the event, the event items, and event data. In a preferred embodiment, an NFT includes an event authentication asset 900, additional information about the authenticated event item, and the NFT serves two primary purposes. The first purpose is to serve as digital proof of authenticity, the second purpose is to serve as a means of ownership tracking, like a deed or a title certificate for property. In an embodiment, the NFT can be generally referred to as “digital title” and more specifically as a Digital Title Certificate. The NFT can include the word “Title” on it along with words conveying authenticity such as “Genuine Certified” or “Certified Genuine.” It is contemplated that the digital title that may be stored on Blockchain can provide links or a code (such as a scannable QR code 1404) so that users can scan the digital title and be directed to a website with additional content related to the physical item.

In an embodiment, the event items will be associated with event content, such as statistics, images, video, song lists, etc. Because the RFID authentication system 100 can reliably read the event item's RFID tag every time the event item is used in an event, all content from all the events where the event item was identified can be associated with the event item. The current state of the art for authenticating event-used items is a practice called “photo matching.” With photo matching, physical items in hand are compared with photographs taken at events where the item(s) were used. If certain photographic elements (e.g., stains on the item, unique markings, loose threads, etc.) can be matched with the actual event-used item in hand the item can be deemed “authentic.” However, those skilled in the art of photo matching understand that photos taken at events cannot always reliably provide photographic evidence that can be matched to the event item(s). Therefore, the RFID authentication system 100 described herein is a needed improvement over the current state of the art.

Referring to FIG. 14A, a pictorial view of digital content of an authentication asset generated for an object is shown in accordance with an embodiment. The digital object 1400 can include data that can be rendered in frames or scenes on a display. In a first frame or scene, the digital object 1400 can include text details corresponding to the item for which the digital object 1400 represents, including information about the event at which the item was used and/or the participant 504 that used the item. In the illustrated example, the text details include the name of the participant 504, the type of item, e.g., game-used shoes, and the location and date of the event. More particularly, the digital object 1400 includes text details of event data, participant data 910 and/or item data 402. The event data can include a date, a type, a venue, a location, a home team, a visiting team, or a final score of the event. The participant data 910 can include a name, a team, or a number of the participant 504. The item data 402 can include a certification, a type, a description, or an associated event number of the object. Such data is provided by way of example and not limitation.

Referring to FIG. 14B, a pictorial view of digital content of an authentication asset generated for an object is shown in accordance with an embodiment. In a second frame or scene, the digital object 1400 can include an authentication video 1402 (when video rights exist) showing the object in use at the event. The authentication video 1402 can include one or more images captured by the camera 502 or mobile device at the event. In an embodiment, the authentication video 1402 can be the authentication asset 900 described above in which a video includes the time data 904, the location data 906, the item data 402, etc., superimposed on the video.

Referring to FIG. 14C, a pictorial view of digital content of an authentication asset generated for an object is shown in accordance with an embodiment. In a third frame or scene, the digital object 1400 can include a QR code 1404. The QR code 1404 can be associated content, or link to a webpage having associated content, including more information about the object. For example, the webpage may include a life story of the object. The life story can have more information about the object and events where it was used or participants 504 that used it. The webpage can be accessed through the QR code 1404 using a camera 502, for example.

The frames or scenes of the authentication asset 900 can be rendered in sequence. More particularly, when the digital object 1400 is opened on a computing system, the first scene of FIG. 14A can be rendered, immediately followed by the second scene of FIG. 14B, which can be immediately followed by the third scene of FIG. 14C.

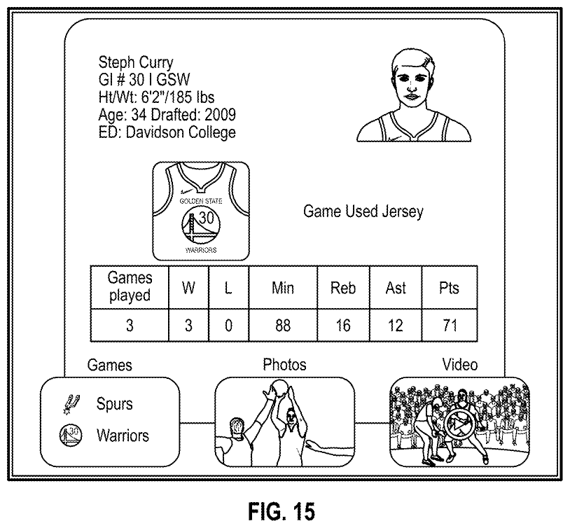

Referring to FIG. 15, a pictorial view of a webpage accessible through digital content of an authentication asset generated for an object is shown in accordance with an embodiment. The associated content can include the website, e.g., the life story, described above. The website, which is accessed through the QR code 1404, can include information about the item at the event. The information may include public information associated with the event. For example, the information can include a song list for a concert at which the object was used, what the object was used for, etc. The life story website therefore provides a rich experience for a consumer, by providing information about the object, including the authentication data described above.

In an embodiment, the RFID authentication system 100 can be used to authenticate objects used in the entertainment industry. For example, the event may be the filming of a television show or a motion picture. During the filming, the RFID reader 106 can capture RFID data 902 associated with the object. Furthermore, presence of the object during the filming can be validated by time data 904 or location data 906 captured by the reference device 108, e.g., a camera 502 used for the filming, or another device present at the filming. In an embodiment, the produced content, e.g., the television show, can include a QR code 1404, e.g., in one or more frames of the show, that may be scanned by a consumer to access information about the object. For example, the QR code 1404 can link to a website having public information about the object. Alternatively, or additionally, the linked website may allow the consumer to purchase the object, be entered into a sweepstakes to within the object, etc.

In any of the above embodiments, the item that is being authenticated, e.g., the object being used at the event, can be tagged. As described above, such tagging may include a RFID tag that can be interrogated by the RFID reader 106 of the RFID authentication system 100. Such tagging allows for the presence of the item at the event to be authenticated, as described above. It will be appreciated, however, that the item may include one or more tags that can allow for interaction with the object at moments outside of the event. For example, an owner of the object, e.g., a person who purchased the object after the event, can interact with the tag on the object to access a consumer experience. The owner may scan the item using a mobile device, for instance. More particularly, the owner may scan a QR code of the tag, scan the tag using near field communications (NFC), etc. The mobile device may be running a software application that receives the tag data and transmits it to the authentication server 104. The authentication server 104 may, in response, generate or return the digital object 1400 for display on the user device. More particularly, the mobile device of the owner can display the digital object 1400 to allow the owner to view and interact with the digital content associated with the item. Alternatively or additionally, the authentication server 104 can generate or return the website described with respect to FIG. 15 for the owner to view. The website can include the life story associated with the item. Accordingly, access to item-associated content, e.g., in a digital object 1400 or a life story website, can be provided by digital displays (FIG. 14C) or physical tags that can be interacted with by consumer devices.

Referring to FIG. 16, a block diagram of an example computing device that may perform one or more of the operations described herein is shown in accordance with some embodiments. More particularly, computing device 1600 may be integrated in any of the servers and/or devices described above to perform any of the described operations. Computing device 1600 may be connected to other computing devices in a LAN, an intranet, an extranet, and/or the Internet. The computing device may operate in the capacity of a server machine in the client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 1600 may include one or more processors (e.g., a processing device, a general purpose processor, a PLD, etc.) 1602, a main memory 1604 (e.g., synchronous dynamic random access memory (DRAM), read-only memory (ROM)), a static memory 1605 (e.g., flash memory and a data storage device 1618), which may communicate with each other via a bus 1630.

The one or more processors 1602 may be provided by one or more general-purpose processing devices such as a microprocessor, central processing unit, or the like. In an illustrative example, processor(s) 1602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor(s) 1602 may also comprise one or more special-purpose processing devices such as an application specific integrated circuit (ASIC), a field programmable gate array (FPGA), a digital signal processor (DSP), network processor, or the like. The processor(s) 1602 may be configured to execute the operations described herein, in accordance with one or more aspects of the present disclosure, for performing the operations and steps discussed herein.

Computing device 1600 may further include a network interface device 1608 which may communicate with the network 102. The computing device 1600 also may include a video display unit 1610 (e.g., a liquid crystal display (LCD) or a cathode ray tube (CRT)), an alphanumeric input device 1612 (e.g., a keyboard), a cursor control device 1614 (e.g., a mouse) and an acoustic signal generation device 1615 (e.g., a speaker). In one embodiment, video display unit 1610, alphanumeric input device 1612, and cursor control device 1614 may be combined into a single component or device (e.g., an LCD touch screen).

Data storage device 1618 may include a non-transitory computer-readable storage medium 1628 on which may be stored one or more sets of instructions 1625 that may include instructions for carrying out the operations described herein, in accordance with one or more aspects of the present disclosure. Instructions 1625 may also reside, completely or at least partially, within main memory 1604 and/or within processor(s) 1602 during execution thereof by computing device 1600, main memory 1604 and processor(s) 1602 also constituting computer-readable media. The instructions 1625 may further be transmitted or received over a network 102 1620 via network 102 interface device 1608.

While computer-readable storage medium 1628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method comprising:
receiving radio frequency identification (RFID) data generated by a RFID reader at an event, wherein the RFID data is associated with a tag on an object at the event;
associating the RFID data with one or more of time data or location data representing the event; and
generating an authentication asset including the RFID data and the one or more of time data or location data.

2. The method of claim 1, wherein associating the one or more of time data or location data includes generating the time data and the location data at the event, and wherein the authentication asset includes the time data and the location data.

3. The method of claim 1 further comprising capturing one or more images of the object being used at the event, wherein the authentication asset includes the one or more images.

4. The method of claim 3, wherein capturing the one or more images includes capturing video including the one or more images of a participant using the object at the event, and further comprising associating the RFID data with participant data representing the participant.

5. The method of claim 4 further comprising displaying the authentication asset, wherein the displayed authentication asset includes the RFID data, one or more of the time data or the location data, and the participant data superimposed on the one or more images.

6. The method of claim 5 further comprising filtering one or more of the RFID data or the participant data based on one or more of an object parameter or a participant parameter, wherein the displayed authentication asset includes only the RFID data or the participant data associated with the object parameter or the participant parameter.

7. The method of claim 1 further comprising:
determining whether event equipment at the event is transmitting RF signals; and
capturing the RFID data in response to determining that the event equipment is not transmitting RF signals.

8. The method of claim 1, wherein the RFID reader is fixed to a venue of the event.

9. The method of claim 8, wherein the RFID reader is fixed to the venue at a location passed by the object during the event.

10. A non-transitory computer-readable medium storing instructions which, when executed by one or more processors of a radio frequency identification (RFID) authentication system, cause the RFID authentication system to perform a method comprising:
capturing, by a radio frequency identification (RFID) reader, RFID data associated with a tag on an object at an event;
associating the RFID data with one or more of time data or location data representing the event; and
generating an authentication asset including the RFID data and the one or more of time data or location data.

11. The non-transitory computer-readable medium of claim 10, wherein associating the one or more of time data or location data includes generating the time data and the location data at the event, and wherein the authentication asset includes the time data and the location data.

12. The non-transitory computer-readable medium of claim 10 further causing the RFID authentication system to perform the method comprising capturing one or more images of the object being used by a participant at the event, wherein the authentication asset includes the one or more images.

13. The non-transitory computer-readable medium of claim 12 further causing the RFID authentication system to perform the method comprising displaying the authentication asset, wherein the displayed authentication asset includes the RFID data, one or more of the time data or the location data, and participant data representing the participant superimposed on the one or more images.

14. The non-transitory computer-readable medium of claim 13 further causing the RFID authentication system to perform the method comprising filtering one or more of the RFID data or the participant data based on one or more of an object parameter or a participant parameter, wherein the displayed authentication asset includes only the RFID data or the participant data associated with the object parameter or the participant parameter.

15. The non-transitory computer-readable medium of claim 10 further causing the RFID authentication system to perform the method comprising:
determine whether event equipment at the event is transmitting RF signals; and
capture the RFID data in response to determining that the event equipment is not transmitting RF signals.

16. A radio frequency identification (RFID) authentication system comprising:
a RFID reader to capture RFID data associated with a tag on an object at an event; and
one or more processors configured to
associate the RFID data with one or more of time data or location data representing the event, and
generate an authentication asset including the RFID data and the one or more of time data or location data.

17. The RFID authentication system of claim 16, wherein associating the one or more of time data or location data includes generating time data and the location data, and wherein the authentication asset includes the time data and the location data.

18. The RFID authentication system of claim 16 further comprising a camera to capture one or more images of the object being used at the event, wherein the authentication asset includes the one or more images.

19. The RFID authentication system of claim 16 further comprising filtering one or more of the RFID data or participant data describing a participant based on one or more of an object parameter or a participant parameter, wherein the participant used the object at the event, and wherein the displayed authentication asset includes only the RFID data or the participant data associated with the object parameter or the participant parameter.

20. The RFID authentication system of claim 16, wherein the one or more processors determine whether event equipment at the event is transmitting RF signals and cause the RFID reader to capture the RFID data in response to determining that the event equipment is not transmitting RF signals.
